(19) United States
(12) Patent Application Publication
(10) Pub. No.: US 2016/0118848 A1
(43) Pub. Date: Apr. 28, 2016

(54) PERMANENT MAGNET MACHINE

(71) Applicant: General Electric Company, Schenectady, NY (US)

(72) Inventors: Tsarafidy RAMINOSOA, Niskayuna, NY (US); Minglong ZHANG, Shanghai (CN); Ayman Mohamed Fawzi EL-REFAIE, Niskayuna, NY (US); Steven Joseph GALIOTI, Niskayuna, NY (US); Patel Bhageerath REDDY, Niskayuna, NY (US)

(21) Appl. No.: 14/924,288

(22) Filed: Oct. 27, 2015

(30) Foreign Application Priority Data
Oct. 27, 2014 (CN) 201410582236.0

(51) Int. Cl. H02K 1/02; H02K 1/17; H02K 1/27; H02K 1/16

(52) U.S. Cl. CPC H02K 1/02; H02K 1/16; H02K 1/17; H02K 1/272

(57) ABSTRACT

A permanent magnet machine includes a stator configured to generate a stator magnetic field when excited with alternating currents and extends along a longitudinal axis with an inner surface defining a cavity, a rotor disposed inside said cavity and configured to rotate about the longitudinal axis, and a plurality of permanent magnets for generating a magnetic field, which interacts with the stator magnetic field to produce a torque. At least one of the plurality of permanent magnets has a light rare earth material including neodymium and praseodymium, and less than about 5 weight percent of a heavy rare earth material, wherein the weight percentage of neodymium is larger than the weight percentage of praseodymium but smaller than three times of the weight percentage of praseodymium.

### STATEMENT REGARDING FEDERALLY SPONSORED RESEARCH AND DEVELOPMENT

This invention was made with Government support under contract number DE-EE0005573 awarded by U.S. Department of Energy. The Government has certain rights in the invention.

### CROSS REFERENCE TO RELATED APPLICATIONS

This application is related to the following Chinese Patent Application Serial No. 201410581804.5, filed Oct. 27, 2014, entitled “Permanent Magnet and Method for Manufacturing the Same” assigned to the same assignee as this application and being filed herewith, the entirety of which is incorporated herein.

### BACKGROUND

The present invention generally relates to a permanent magnet machine and more particularly, to a permanent magnet machine with permanent magnets with reduced heavy rare earth material.

Permanent magnet (PM) machines such as PM motors or generators have been widely used in a variety of applications including aircraft, automobiles and industrial usage. It is important for lightweight and high power density PM machines to maximize the power to weight ratios. Therefore, it is desirable to have a PM machine with high power density and efficiency and reduced mass and cost. However, in order to achieve better magnetic properties such as higher coercivity, heavy rare earth elements with high magneto-crystalline anisotropy fields, such as terbium (Tb) and dysprosium (Dy), are added into the permanent magnet. Heavy rare earth elements such as Tb and Dy are expensive elements and a small content of them may significantly increase the cost of the magnet. Accordingly, it is desirable to develop permanent magnets with minimized heavy rare earth elements but with compatible magnetic properties, which can be used to obtain a PM machine with high power density and efficiency and reduced mass and cost.

### BRIEF DESCRIPTION

Embodiments of the present disclosure relates to a permanent magnet machine. The permanent magnet machine includes a stator configured to generate a stator magnetic field when excited with alternating currents and extends along a longitudinal axis with an inner surface defining a cavity, a rotor disposed inside said cavity and configured to rotate about the longitudinal axis, and a plurality of permanent magnets for generating a magnetic field, which interacts with the stator magnetic field to produce a torque. At least one of the plurality of permanent magnets has a light rare earth material including neodymium and praseodymium, and less than about 5 weight percent of a heavy rare earth material, wherein the weight percentage of neodymium is larger than the weight percentage of praseodymium but smaller than three times of the weight percentage of praseodymium.

### BRIEF DESCRIPTION OF THE DRAWINGS

The above and other aspects, features, and advantages of the present disclosure will become more apparent in light of the subsequent detailed description when taken in conjunction with the accompanying drawings in which:

FIG. 1 is a perspective view of a flux switching PM machine in accordance with an exemplary embodiment of the invention.

FIG. 2 is a perspective view of an interior PM spoke machine in accordance with an exemplary embodiment of the invention.

FIG. 3 is a perspective view of a V-shape interior PM machine in accordance with an exemplary embodiment of the invention.

FIG. 4 is a perspective view of a double-layer interior PM machine in accordance with an exemplary embodiment of the invention.

FIG. 5 is a graph showing demagnetization curves of a permanent magnet sample S1.

FIG. 6 is a graph showing demagnetization curves of a permanent magnet sample S2.

FIG. 7 is a graph showing demagnetization curves of a permanent magnet sample S3.

FIG. 8 is a graph showing demagnetization curves of a permanent magnet sample S4.

FIG. 9 is a graph showing demagnetization curves of a permanent magnet sample S5.

FIG. 10 is a graph showing demagnetization curves of a permanent magnet sample S6.

FIG. 11 is a graph showing demagnetization curves of a permanent magnet sample S7.

### DETAILED DESCRIPTION

One or more specific embodiments of the present disclosure will be described below. Unless defined otherwise, technical and scientific terms used herein have the same meaning as is commonly understood by one of ordinary skill in the art to which this invention belongs.

The terms “a” and “an” do not denote a limitation of quantity, but rather denote the presence of at least one of the referenced items. The term “or” is meant to be inclusive and mean either or all of the listed items. The use of “including,” “comprising” or “having” and variations thereof herein are meant to encompass the items listed thereafter and equivalents thereof as well as additional items. Approximating language, as used herein throughout the specification and claims, may be applied to modify any quantitative representation that could permissibly vary without resulting in a change in the basic function to which it is related. Accordingly, a value modified by a term or terms, such as “about” and “substantially”, are not to be limited to the precise value specified. Additionally, when using an expression of “about a first value—a second value,” the about is intended to modify both values. In at least some instances, the approximating language may correspond to the precision of an instrument for measuring the value. Here, and throughout the specification and claims, range limitations may be combined and/or interchanged, such ranges are identified and include all the sub-ranges contained therein unless context or language indicates otherwise.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

As used herein, “rare earth material” refers to a collection of seventeen chemical elements in the periodic table, including scandium, yttrium, the fifteen lanthanoids, and any combination thereof. The fifteen lanthanoids include lanthanum, cerium, praseodymium, neodymium, promethium, samarium, europium, gadolinium, terbium, dysprosium, holmium, erbium, thulium, ytterbium, lutetium. As used herein, “light rare earth material” comprises scandium, yttrium, lanthanum, cerium, praseodymium, neodymium, promethium, samarium, europium, or any combination thereof. As used herein, “heavy rare earth material” comprises gadolinium, terbium, dysprosium, holmium, erbium, thulium, ytterbium, lutetium or any combination thereof.

Embodiments of the present disclosure relate to permanent magnet (PM) machines in which permanent magnets with reduced rare earth material (especially the heavy rare earth material such as dysprosium) are used. Such PM machines have high power density and efficiency and reduced mass and cost. Examples of these PM machines include but are not limited to, flux switching PM machines, spoke interior PM machines, V-shaped interior PM machines, and double-layer or multilayer interior PM machines.

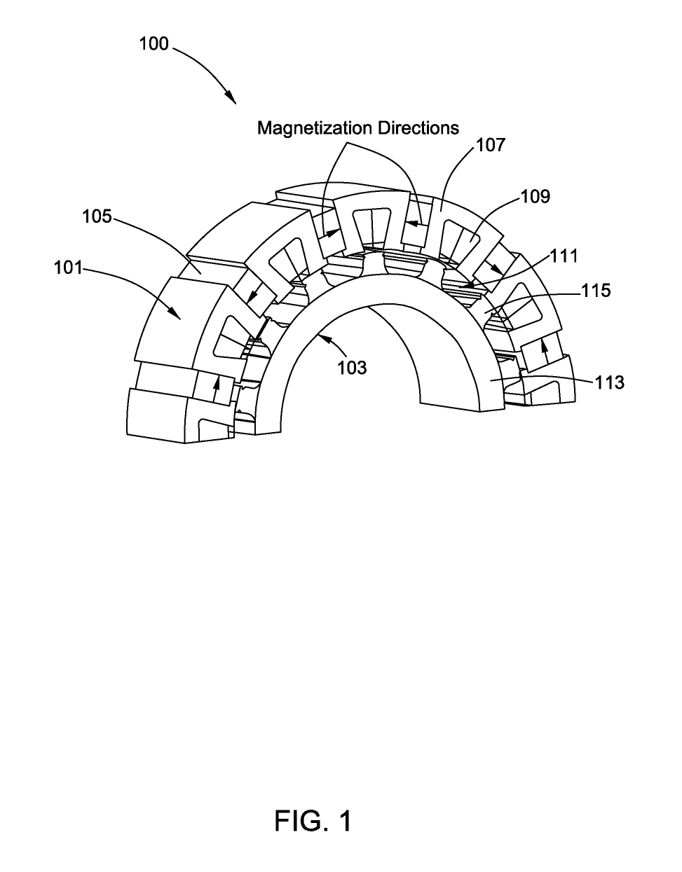

Referring to FIG. 1, which illustrates a perspective view of a flux switching PM machine 100. The machine 100 includes a stator 101, a rotor 103 and a plurality of permanent magnets 105. The stator 101 includes a stator core 107 and a plurality of stator windings 109 disposed in the stator core 107, and it is configured to generate a stator magnetic field when excited with alternating currents and extends along a longitudinal axis with an inner surface defining a cavity 111. The rotor 103 is disposed inside the cavity 111 and configured to rotate about the longitudinal axis, and it includes a rotor core 113 and a plurality of protrusions 115 projecting from the rotor core 113. The protrusions 115 function as rotor poles. The plurality of permanent magnets 105 are disposed on the stator 101. The permanent magnets 105 are magnetized circumferentially with alternating polarities along the circumferential direction. In the illustrated embodiment, the stator core 107 includes a plurality of C-shaped core parts arranged along a circumferential direction thereof. Each of the C-shaped core parts defines a cavity for accommodating one of the stator windings 109. Each of the permanent magnets 105 is sandwiched between two adjacent C-shaped core parts.

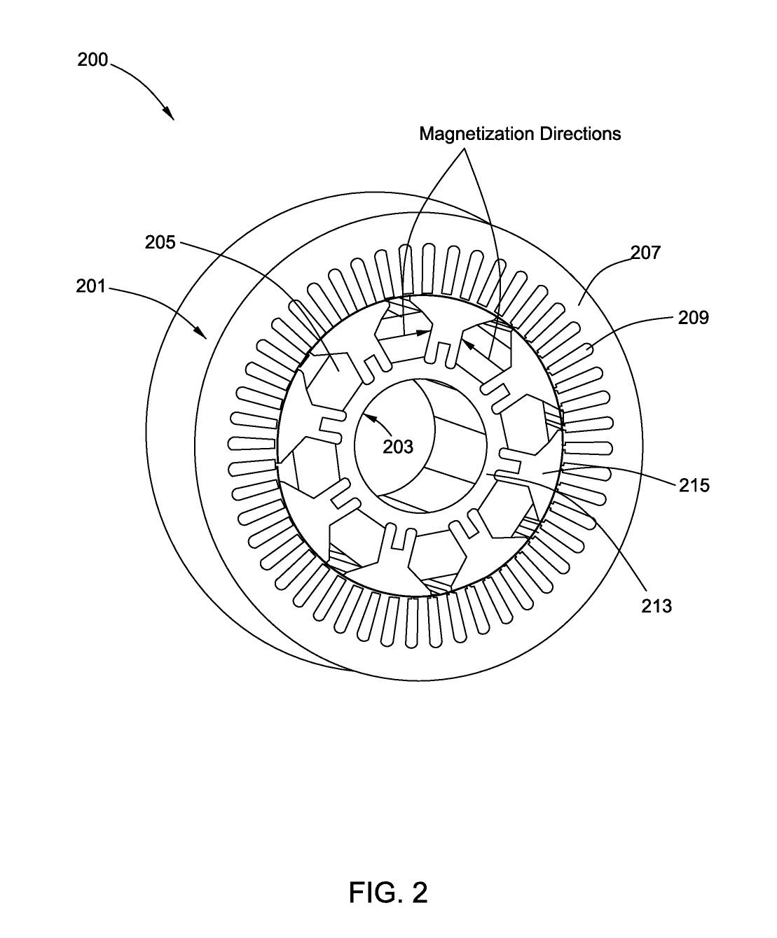

Referring to FIG. 2, which illustrates a perspective view of an interior PM spoke machine 200. The machine 200 includes a stator 201, a rotor 203 and a plurality of permanent magnets 205. The stator 201 includes a stator core 207 and a plurality of stator windings 209 disposed in the stator core 207, and it is configured to generate a stator magnetic field when excited with alternating currents and extends along a longitudinal axis with an inner surface defining a cavity for accormmodating the rotor 203. The rotor 203 is disposed inside the cavity and configured to rotate about the longitudinal axis, and it includes a rotor shaft 213 and a plurality of rotor poles 215 assembled on the rotor shaft 213. The plurality of permanent magnets 205 are disposed on the rotor 203 and are arranged and oriented like spokes. As shown in FIG. 2, each of the permanent magnets 205 has a magnetization direction substantially parallel to the circumferential direction of the rotor 203. The polarities of the permanent magnets alternate along the circumferential direction.

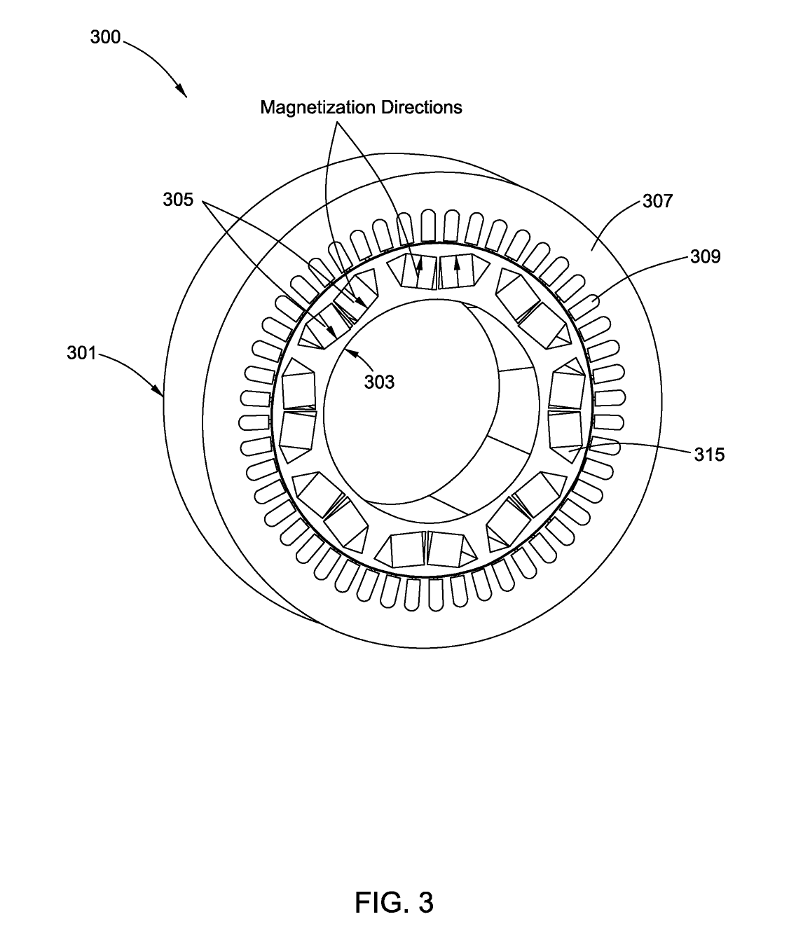

Referring to FIG. 3, which illustrates a perspective view of a V-shape interior PM machine 300. The machine 300 includes a stator 301, a rotor 303 and a plurality of permanent magnets 305. The stator 301 includes a stator core 307 and a plurality of stator windings 309 disposed in the stator core 307, and it is configured to generate a stator magnetic field when excited with alternating currents and extends along a longitudinal axis with an inner surface defining a cavity for accormmodating the rotor 303. The rotor 303 is disposed inside the cavity and configured to rotate about the longitudinal axis, and it includes a plurality of PM cavities 315. The plurality of permanent magnets 305 are disposed inside the PM cavities 315 and arranged like V-shapes respectively. As shown in FIG. 3, each of the permanent magnets 305 has a magnetization direction substantially perpendicular to the lateral dimension of the permanent magnet 305 in order to create a substantially radial resultant magnetic field in the airgap.

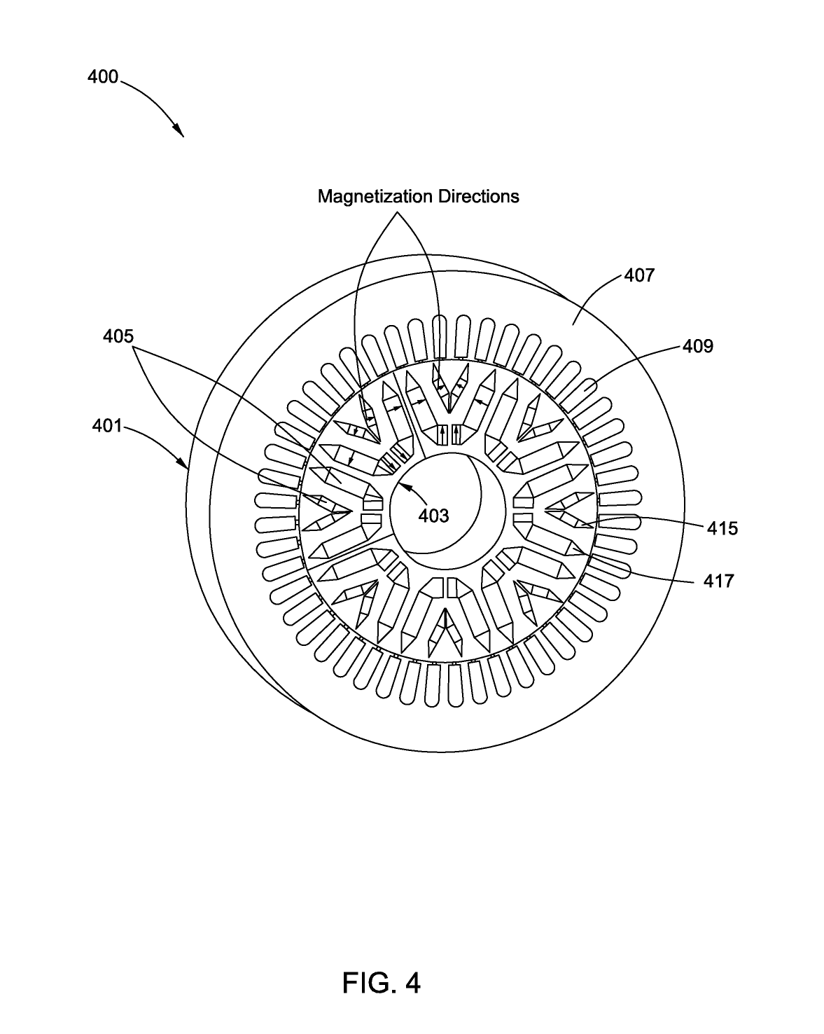

Referring to FIG. 4, which illustrates a perspective view of a double-layer interior PM machine 400. The machine 400 includes a stator 401, a rotor 403 and a plurality of permanent magnets 405. The stator 401 includes a stator core 407 and a plurality of stator windings 409 disposed in the stator core 407, and it is configured to generate a stator magnetic field when excited with alternating currents and extends along a longitudinal axis with an inner surface defining a cavity for accommodating the rotor 403. The rotor 403 is disposed inside the cavity and configured to rotate about the longitudinal axis, and it includes two layers of PM cavities, for example, a layer of V-shaped PM cavities 415 and a layer of U-shaped PM cavities 417 as illustrated. Each of the permanent magnets 405 includes a U-shape part and a V-shape part, disposed in the U-shaped PM cavity 417 and V-shaped PM cavity 415, respectively. Openings of both U-shape part and V-shape part are facing the same way, i.e., both are outwards-facing (as shown in FIG. 4) or both are inwards-facing. The magnetization directions of the permanent magnet 405 are as shown in FIG. 4. The permanent magnets 405 are magnetized in a way to produce a substantially radial resultant magnetic field in the airgap. The shapes of the PM cavities may be changed and the number of layers may be increased depending on actual needs. For example, the two layers of PM cavities 415 and 417 may be both V-shaped PM cavities (Double V type), both U-shaped PM cavities (Double U type), a layer of straight PM cavities and a layer of V-shaped PM cavities, a layer of straight PM cavities and a layer of U-shaped PM cavities, or in any other possible configurations. There may be more than two layers of PM cavities in the rotor 403 (as for multilayer interior PM machine).

At least one of the permanent magnets used in the PM machine as described above is a permanent magnet with reduced heavy rare earth material. In certain embodiments, at least one of the permanent magnets used in the PM machine as described above is a dysprosium-free or dysprosium-reduced permanent magnet. The permanent magnet includes from about 23 weight percent to about 34 weight percent of a light rare earth material including neodymium and praseodymium, wherein the weight percentage of neodymium is larger than the weight percentage of praseodymium but smaller than three times of the weight percentage of praseodymium (Pr<Nd<3Pr). Praseodymium can improve the coercivity (Hcj) of a magnet, which is important for high temperature applications, but this element provides relatively poorer temperature stability, whereas neodymium can increase the temperature stability. The composition described herein provides both improved coercivity (Hcj) and a desirable level of thermal stability. The weight percentage of neodymium relative to the entire permanent magnet may be in a range from about 13 weight percent to about 20 weight percent. The weight percentage of praseodymium relative to the entire permanent magnet may be in a range from about 7 weight percent to about 14 weight percent.

The permanent magnet further includes less than about 5 weight percent of a heavy rare earth material. In certain embodiments, the heavy rare earth material includes dysprosium, holmium, or a combination thereof. For example, in a specific embodiment, the permanent magnet includes less than about 4.5 weight percent of dysprosium, less than about 0.8 weight percent of holmium and less than about 0.02 weight percent of terbium. In a specific embodiment, the permanent magnet includes less than 0.02 weight percent of dysprosium, less than about 0.02 weight percent of holmium and less than about 0.02 weight percent of terbium. In consideration of the impurities that possibly exist in the material for fabricating the permanent magnet, “less than about 0.02 weight percent of an element (e.g., terbium, dysprosium or holmium)” as used herein can be considered substantially free of that element.

In certain embodiments, the weight percentage of rare earth material, including the light rare earth material and heavy rare earth material, relative to the entire permanent magnet is in a range from about 28 weight percent to about 34 weight percent. In certain embodiments, the range is from about 28 weight percent to about 32 weight percent.

The permanent magnet further includes a metallic alloy component including niobium, copper, cobalt, aluminum, gallium, zirconium or combinations thereof, and the balance includes iron, boron or a combination thereof, with or without impurities.

In certain embodiments, the permanent magnet includes niobium. The weight percentage of niobium relative to the entire permanent magnet may be in a range from about 0.1 weight percent to about 0.8 weight percent, and in certain embodiments from about 0.1 weight percent to about 0.5 weight percent, and in particular embodiments from about 0.15 weight percent to about 0.4 weight percent. In certain embodiments, the permanent magnet includes copper. The weight percentage of copper relative to the entire permanent magnet may be more than about 0.2 weight percent, and in certain embodiments in a range from about 0.4 weight percent to about 1.2 weight percent. In certain embodiments, the permanent magnet includes cobalt. The weight percentage of cobalt relative to the entire permanent magnet may be in a range from about 0.5 weight percent to about 4.4 weight percent, and in certain embodiments from about 0.8 weight percent to about 1.8 weight percent.

In certain embodiments, the permanent magnet includes more than about 1 weight percent of aluminum. For example, in some embodiments, a weight percentage of dysprosium relative to the entire permanent magnet is smaller than about 0.02 weight percent, and the weight percentage of aluminum relative to the entire permanent magnet is larger than about 1.5 weight percent. In alternative embodiments, a weight percentage of dysprosium relative to the entire permanent magnet is larger than about 0.02 weight percent, and the weight percentage of aluminum relative to the entire permanent magnet is in a range from about 1 weight percent to about 1.5 weight percent.

In certain embodiments, the permanent magnet includes gallium, zirconium or their combinations. The weight percentage of gallium relative to the entire permanent magnet may be less than about 0.5 weight percent. The weight percentage of zirconium relative to the entire permanent magnet may be less than about 0.3 weight percent.

The permanent magnet has small and uniform grain size, which helps improve the performance properties. In certain embodiments, an average grain size of the permanent magnet is in a range from about 1.5 microns to about 4 microns, and in particular embodiments from about 2 microns to about 3 microns.

The permanent magnet as described herein possesses a good balance between cost-effectiveness and performance properties including intrinsic coercivity, remanence and maximum energy product.

As used herein, “coercivity” or “coercive force” (Hcb) is a property of the permanent magnet that represents the amount of demagnetizing force needed to reduce the induction of the permanent magnet to zero after the magnet has previously been brought to saturation. Typically, the larger the coercivity or coercive force, the greater the stability of the magnet in a high-temperature environment and the less the magnet is affected by an external magnetic field. “Intrinsic coercivity” or “intrinsic coercive force” (Hcj) of the magnet is the magnetic material's inherent ability to resist demagnetization corresponding to a zero value of intrinsic induction or magnetic polarization (J). “Maximum energy product” ((BH)max) is another property of the permanent magnet that refers to a product of the magnetic flux density (B) and a magnetic field strength (H) in the permanent magnet. A higher maximum energy product ((BH)max) represents that the permanent magnet has a higher density of magnetic energy. “Remanence” (Br) refers the magnetization left behind in a medium after an external magnetic field is removed. A higher remanence represents that the permanent magnet material has a higher resistance to be demagnetized.

In certain embodiments, a sum of intrinsic coercivity in the unit of kilo Oersted (kOe) and maximum energy product in unit of mega gauss Oersteds (MGOe) of the permanent magnet is at least about 55, and in particular embodiments, it is at least about 58. The sum of intrinsic coercivity and maximum energy product is an important parameter for comprehensive assessment of performance properties of the permanent magnet.

In another aspect, embodiments of the present disclosure relate to a method for producing the permanent magnet. In certain embodiments, an alloy powder with a composition substantially equal to that of the permanent magnet as described above is provided. The alloy powder is shaped into a powder compact, which is then sintered and annealed. In alternative embodiments, the permanent magnet is produced via a multi-alloy method. In the multi-alloy method, a main-alloy powder is mixed with an assist-alloy powder to form a powder mixture, which has a composition substantially equal to that of the permanent magnet as described above. The powder mixture is shaped into a powder compact, which is then sintered and annealed. Both the main-alloy powder and assist-alloy powder include rare earth materials. The weight percentage of rare earth materials in the main-alloy powder is lower than that in the assist-alloy powder. In a specific embodiment, the main-alloy powder includes less than about 32 weight percent of rare earth materials and the assist-alloy powder includes more than about 32 weight percent of rare earth materials.

Any one of the three kinds of powders as described above may be provided by a process including steps of: forming a melted alloy (e.g., main-alloy or assist-alloy); solidifying the melted alloy to form flakes; crushing the flakes into particles; dehydrogenating the particles; and milling the particles to form a powder with an average particle diameter in a range, for example, from about 1.5 microns to about 3.5 microns. The melted alloy may be formed by melting the raw materials, which includes the rare earth materials, metallic alloy component, iron and boron together. In certain embodiments, the melted alloy may be obtained by an induction melting. The melted alloy may be solidified by strip-casting. The flakes may be crushed into particles by hydrogen decrepitation. The particles may be jet-milled to form the powder.

In certain embodiments, the strip-casting is carried out in vacuum of not more than about 0.01Pa. In certain embodiments, the flakes formed by the strip-casting have thicknesses in a range from about 200 microns to about 300 microns. In particular embodiments, the range is from about 200 microns to about 250 microns. In certain embodiments, the hydrogen decrepitation is carried out with a hydrogen pressure of not less than about 0.1 Mpa. In certain embodiments, the dehydrogenation is carried out in a vacuum environment of from about 400° C. to about 700° C. In certain embodiments, there may be more than one time of milling (e.g., jet-milling) in order to get fine alloy powders. In certain embodiments, the main-alloy particles are milled to form a main-alloy powder with an average particle diameter in a range from about 2.5 microns to about 3.5 microns, and the assist-alloy particles are milled to form an assist-alloy powder with an average particle diameter in a range from about 1.5 microns to about 2.5 microns.

The powder may be shaped into a powder compact in a magnetic field. In certain embodiments, the powder mixture is shaped into a powder compact by molding the powder mixture into a powder compact in a magnetic field of not less than about 1.5 Tesla, and isostatically pressing the powder compact in oil under a pressure of not less than about 150 MPa.

In certain embodiments, the compact is sintered at a temperature in a range from about 1020° C. to about 1120° C. for a time duration in a range from about 1 hour to about 5 hours. In certain embodiments, the sintered compact is annealed at a temperature in a range from about 800° C. to about 1000° C. for a time duration in a range from about 1 hour to about 5 hours. In certain embodiments, the annealed compact is further aged at a temperature in a range from about 450° C. to about 650° C. for a time duration in a range from about 1 hour to about 5 hours. The annealing and aging treatment can improve the microstructure of the permanent magnet and thereby significantly improve the magnetic properties, especially Hcj and (BH)max. During annealing and aging, the Nd-rich phase around the grain boundary may be flowed, which makes the Nd distribution around the grain boundary more uniform, and also makes the grain much smoother because the flowing liquid phase may dissolve the sharp parts. Nd-rich phase typically is a significant contributor to overall magnetic properties, especially Hcj.

The embodiments of the present disclosure are demonstrated with reference to some non-limiting examples. The following examples are set forth to provide those of ordinary skill in the art with a detailed description of how the methods claimed herein are evaluated, and are not intended to limit the scope of what the inventors regard as their invention.

### EXAMPLES

In the examples, seven permanent magnet samples were produced via the multi-alloy method as discussed above, in which a powder mixture is obtained by mixing one or more main-alloy powders with at least one assist-alloy powder and shaped into a powder compact, which is then sintered and annealed. Four main-alloys (M1-M4) and three assist-alloys (A1-A3) were used in the examples. Compositions by weight percent of these main-alloys and assist-alloys are illustrated in Table 1 below. In Table 1, the item PrNd means an alloy which includes 20 wt % of Pr and 80 wt % of Nd. Similarly, DyFe includes 80 wt % of Dy and 20 wt % of Fe, HoFe includes 80 wt % of Ho and 20 wt % of Fe, ZrFe includes 60 wt % of Zr and 40 wt % of Fe, NbFe includes 65 wt % of Nb and 35 wt % of Fe, and BFe includes 20 wt % of B and 80 wt % of Fe.

TABLE 1
Compositions by weight percent of main-alloys and assist-alloys

| Composition | | PrNd | Pr | DyFe | HoFe | Co | Cu | Al | Ga | ZrFe | NbFe | BFe | Fe |
|---|---|---|---|---|---|---|---|---|---|---|---|---|---|
| Alloys | A1 | 40.00 | 0.00 | 0.00 | 0.00 | 1.00 | 0.50 | 0.60 | 0.00 | 0.10 | 0.46 | 5.15 | 52.18 |
| | A2 | 40.00 | 0.00 | 0.00 | 0.00 | 0.50 | 0.80 | 1.60 | 0.00 | 0.05 | 0.00 | 5.15 | 51.90 |
| | A3 | 20.00 | 0.00 | 25.00 | 0.00 | 1.00 | 0.10 | 0.15 | 0.00 | 0.00 | 0.31 | 5.15 | 48.29 |
| | M1 | 16.00 | 14.00 | 0.00 | 0.00 | 1.00 | 0.10 | 0.20 | 0.20 | 0.08 | 0.06 | 5.11 | 63.44 |
| | M2 | 28.00 | 0.00 | 0.00 | 3.75 | 2.00 | 0.50 | 0.80 | 0.00 | 0.20 | 0.46 | 5.15 | 59.13 |
| | M3 | 25.60 | 0.00 | 5.30 | 3.19 | 1.85 | 0.50 | 0.80 | 0.20 | 0.16 | 0.39 | 5.16 | 56.93 |
| | M4 | 15.50 | 15.50 | 0.00 | 0.00 | 1.00 | 0.10 | 0.15 | 0.00 | 0.00 | 0.31 | 5.15 | 62.29 |

Each of the main-alloys M1-M4, with the nominal composition as in Table 1, was melted at about 1600° C. and then strip-casted to flakes with thicknesses of about 200-300 microns in vacuum of about 0.01Pa. The strip-casting flakes were decrepitated at a room temperature with a hydrogen pressure of about 0.2 MPa to get coarse particles, and this step was followed by about 2 hours of dehydrogenation with vacuum of about 5Pa and temperature of about 580° C. The coarse particles were converted to fine powders with average diameters of about 2.5-3.5 microns by jet-milling. Through similar processes, uniform fine powders of the assist-alloys A1-A3, with average diameters of about 1.5-2.5 microns were obtained. By mixing the main alloy powder(s) with assist-alloy powder(s) at given weight ratios as shown in Table 2 below, powder mixtures of different compositions were obtained. Each of the powder mixtures was aligned and pressed into a green compact by molding in a field of about 2.0 Tesla, which was further pressed isostatically in oil under pressure of about 200 MPa to improve its density. The green compacts were subjected to a sintering and annealing process as illustrated in Table 2 below, to get preform of the permanent magnet samples (S1-S7).

TABLE 2
Mixing formulas and sintering and annealing conditions

| Samples | Formula | Sintering and Annealing Conditions |
|---|---|---|
| S1 | 84 wt % M1 + 16 wt % A1 | 1053° C. * 3 h + 900° C. * 2 h + 480° C. * 2 h |
| S2 | 80 wt % M1 + 20 wt % A1 | 1060° C. * 2 h + 900° C. * 2 h + 480° C. * 2 h |
| S3 | 75 wt % M1 + 25 wt % A1 | 1068° C. * 2 h + 900° C. * 2 h + 480° C. * 2 h |
| S4 | 60 wt % M1 + 20 wt % M2 + 20 wt % A1 | 1065° C. * 2 h + 900° C. * 2 h + 480° C. * 2 h |
| S5 | 30 wt % M1 + 40 wt % M2 + 20 wt % M3 + 10 wt % A1 | 1065° C. * 2 h + 900° C. * 2 h + 480° C. * 2 h |
| S6 | 85 wt % M4 + 7 wt % A2 + 8 wt % A3 | 1048° C. * 2 h + 900° C. * 2 h + 480° C. * 2 h |
| S7 | 77.5 wt % M4 + 7.5 wt % A2 + 15 wt % A3 | 1048° C. * 2 h + 900° C. * 2 h + 480° C. * 2 h |

As illustrated in Table 2, each of the compacts was sintered in vacuum at about 1020-1120° C. for about 2-3 hours to reach full densification and then quenched to a room temperature. Then an annealing process including a post-sintering process at about 800-1000° C. for about 2 hours followed by quenching to a room temperature and optionally an aging process at about 450-500° C. for about 2 hours was employed to obtain desired properties. The preforms were machined and polished into desired dimension and then coated with a passivation layer to get the finished permanent magnet samples. Compositions by weight percent of the seven permanent magnet samples S1-S7 are illustrated in Table 3 below. The compositions of the main-alloys, assist-alloys and samples were analyzed through an Inductive Coupled Plasma Atomic Emission Spectrometry (ICP-AES).

It should be understood that the composition of a final sample may be slightly different from that of the powder mixture for producing the sample because the composition may slightly change during the process of making the sample. For example, the aluminum content in a final sample may be slightly higher than that of the powder mixture for producing the sample because an aluminum device or container (such as a crucible) is used for the sample production.

TABLE 3
Compositions by weight percent of the permanent magnet samples

| Samples | Pr | Nd | Dy | Tb | Ho | Co | Cu | Al | Ga | Zr | Nb | B | Fe |
|---|---|---|---|---|---|---|---|---|---|---|---|---|---|
| S1 | 13.30 | 15.87 | <0.02 | <0.02 | <0.02 | 1.11 | 0.67 | 1.59 | 0.26 | 0.09 | 0.15 | 1.01 | 65.95 |
| S2 | 12.99 | 16.64 | <0.02 | <0.02 | <0.02 | 1.11 | 0.76 | 1.71 | 0.25 | 0.09 | 0.17 | 1.01 | 65.28 |
| S3 | 12.60 | 17.60 | <0.02 | <0.02 | <0.02 | 1.11 | 0.84 | 1.83 | 0.23 | 0.10 | 0.19 | 1.01 | 64.49 |
| S4 | 11.03 | 18.56 | <0.02 | <0.02 | 0.23 | 1.33 | 1.09 | 2.44 | 0.18 | 0.12 | 0.27 | 1.01 | 63.73 |
| S5 | 7.45 | 19.90 | 1.20 | <0.02 | 0.66 | 1.73 | 0.52 | 1.05 | 0.23 | 0.20 | 0.40 | 1.00 | 65.66 |
| S6 | 13.48 | 13.93 | 2.26 | <0.02 | <0.02 | 1.07 | 0.40 | 1.10 | <0.02 | <0.02 | 0.35 | 1.00 | 66.40 |
| S7 | 12.61 | 14.27 | 4.25 | <0.02 | <0.02 | 1.06 | 0.40 | 1.10 | <0.02 | <0.02 | 0.34 | 1.00 | 64.98 |

The properties of the samples S1-S7 were measured at a room temperature and compared. In the examples, properties including remanence (Br), intrinsic coercivity (Hcj), coercive force (Hcb) and maximum energy product ((BH)max) were measured at about 20° C. and listed in Table 4 below.

TABLE 4
Comparison of properties of the permanent magnet samples

Magnetic Property at 20° C.

| Samples | Br/kGs | Hcj/kOe | Hcb/kOe | (BH)max/MGOe |
|---|---|---|---|---|
| S1 | 12.64 | 18.89 | 12.63 | 39.5 |
| S2 | 12.58 | 19.17 | 12.35 | 38.58 |
| S3 | 12.13 | 21.91 | 12.1 | 36.38 |
| S4 | 12.55 | 20.1 | 12.4 | 38.94 |
| S5 | 12.77 | 20.85 | 12.58 | 40.14 |
| S6 | 12.6 | 23.29 | 12.25 | 38.9 |
| S7 | 12.23 | 24.23 | 12.01 | 36.65 |

As can be seen in Table 3 and Table 4, the permanent magnet samples S1-S7 contain very low amounts of, or no, heavy rare earth elements yet have a remanence greater than about 12 kGs, an intrinsic coercive force greater than about 18 kOe, a coercive force greater than about 12 kOe, and a maximum energy product greater than about 36 MGOe. The samples S3-S7 have an intrinsic coercive force greater than about 20 kOe, wherein the samples S6 and S7 have an intrinsic coercive force greater than about 23 kOe. Moreover, as for each of the samples S1-S7, a sum of intrinsic coercivity in the unit of kilo Oersted (kOe) and maximum energy product in unit of mega gauss Oersteds (MGOe) is higher than about 57.

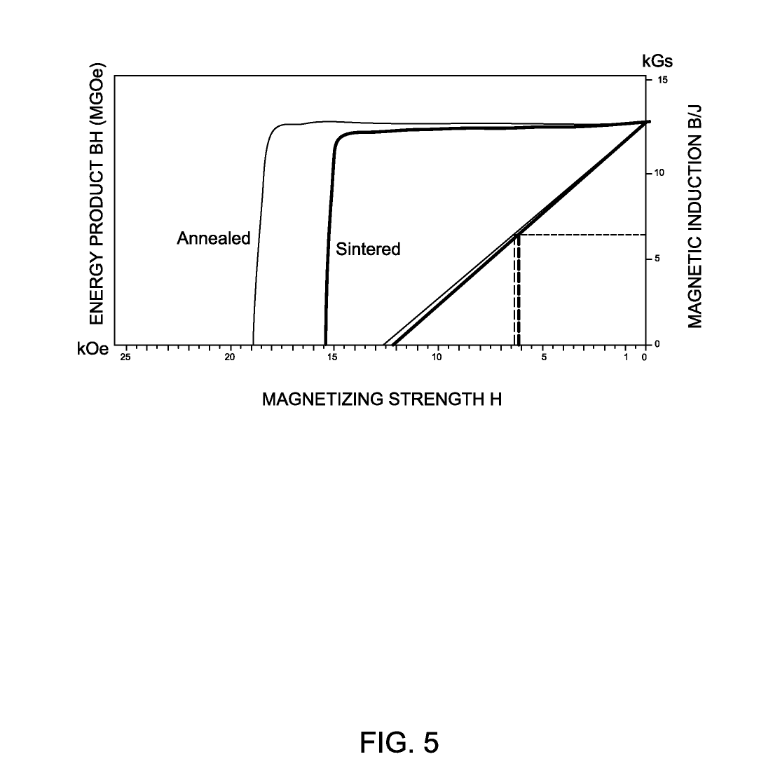

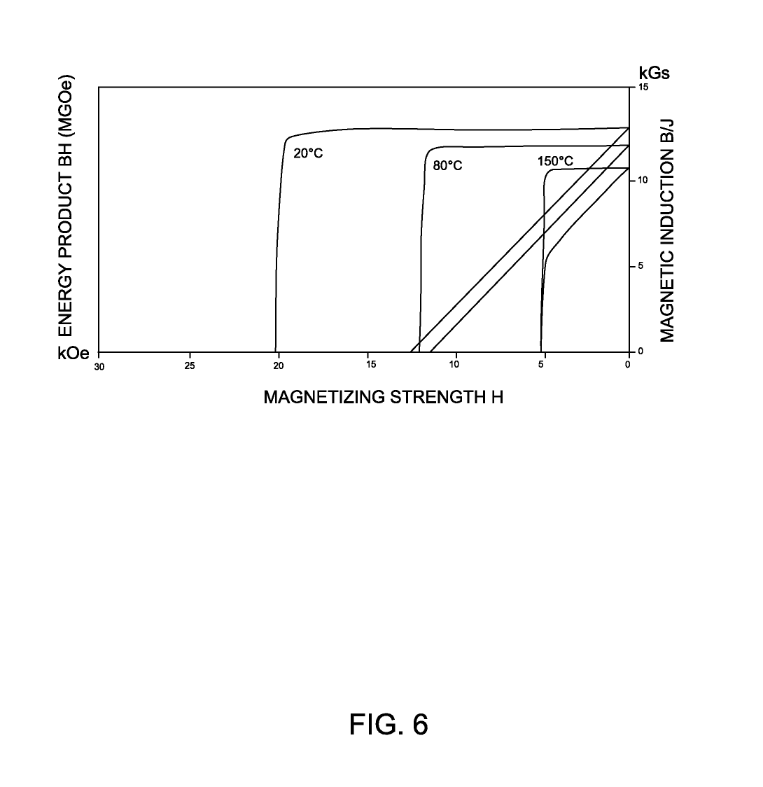

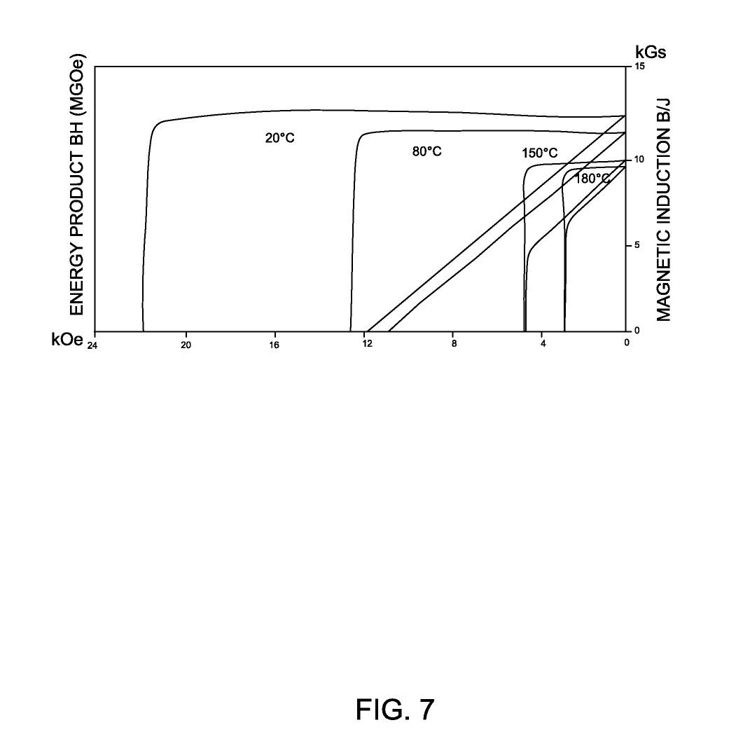

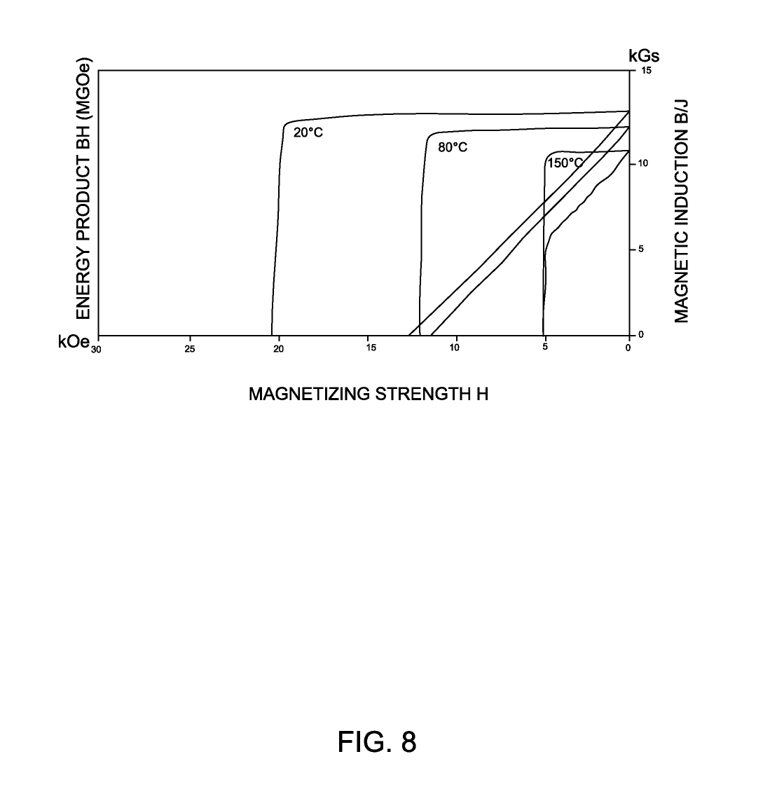

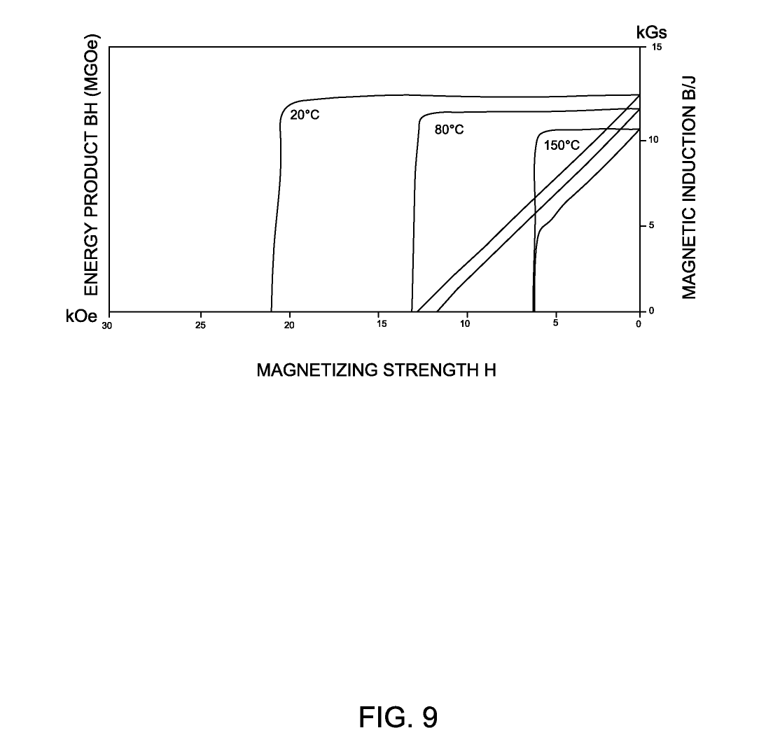

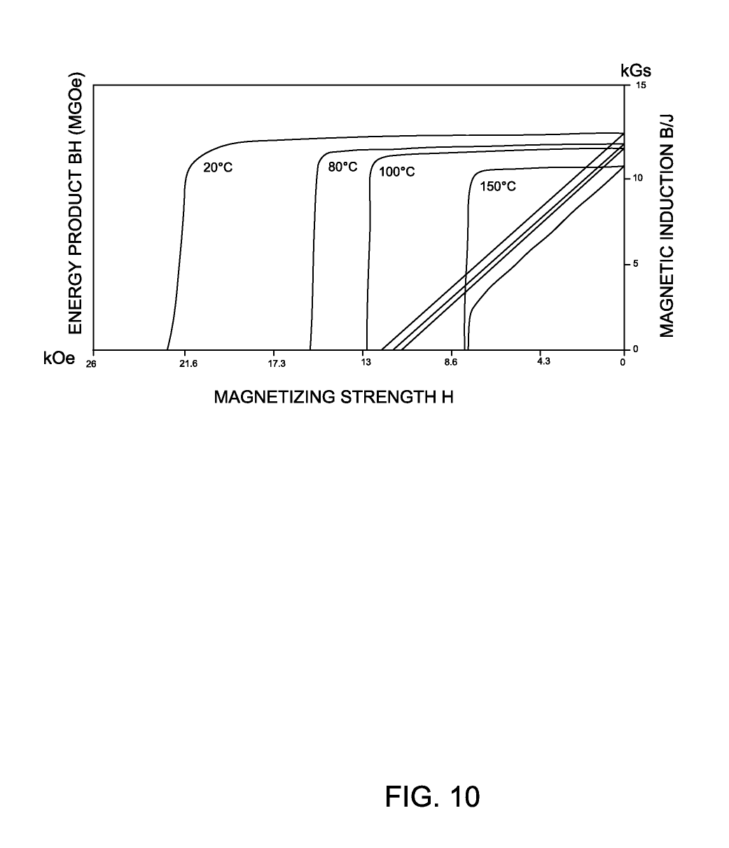

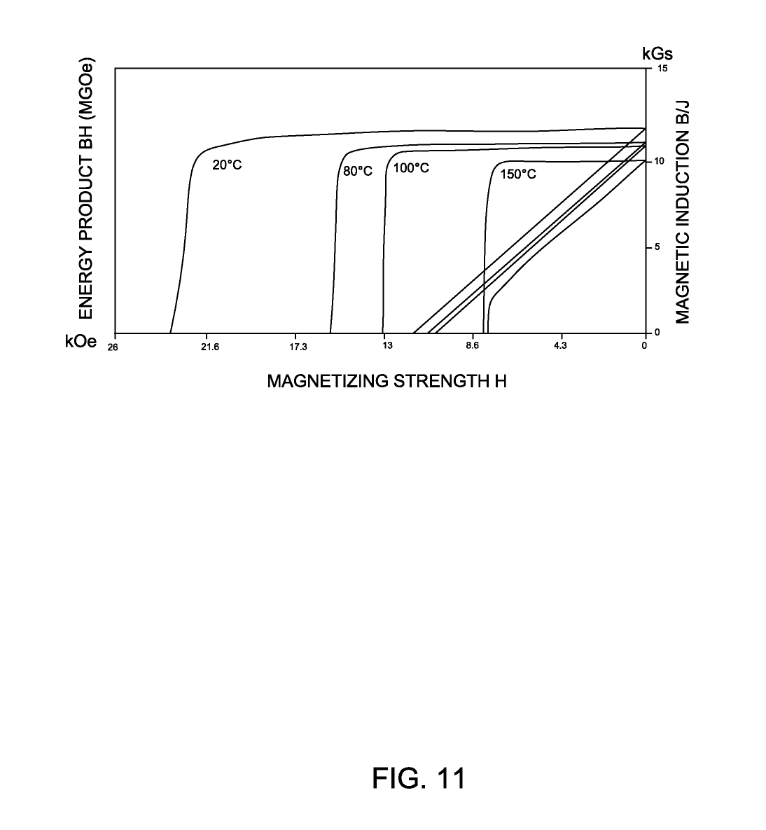

For the purposes of reference to evaluation of the magnetization characteristics, FIGS. 5-11 show demagnetization curves of the permanent magnet samples S1-S7, respectively. FIG. 5 shows two demagnetization curves measured after the sample S1 being sintered and annealed, respectively. Each of FIGS. 6-11 shows two or more demagnetization curves to reflect different operating temperatures. “Demagnetization curve” as used herein refers to a graph of magnetic induction (magnetic flux density (B)/magnetic polarization (J)) versus the demagnetizing force imposed on the magnet (magnetizing strength H), as the magnetic field is reduced to 0 from its saturation value. A demagnetization curve may include a B-H curve and a J-H curve. In a demagnetization graph, remanence (Br) typically is equal to the value of B/J where the demagnetization curve intersects the B/J axis, whereas coercive force (Hcb) typically is equal to the value of H where the B-H curve intersects the H axis, and intrinsic coercivity (Hcj) typically is equal to the value of H where the J-H curve intersects the H axis. As shown in FIGS. 5-11, the permanent magnet samples show high Br, Hcj and Hcb, and the J-H curves show good squareness/rectangularity, which represents the permanent magnet samples also have maximum energy products ((BH)max).

This written description uses examples to describe the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A permanent magnet machine comprising:
a stator configured to generate a stator magnetic field when excited with alternating currents and extends along a longitudinal axis with an inner surface defining a cavity;
a rotor disposed inside said cavity and configured to rotate about the longitudinal axis; and,
a plurality of permanent magnets for generating a magnetic field, wherein the magnetic field interacts with the stator magnetic field to produce a torque, at least one of the plurality of permanent magnets comprising:
a light rare earth material comprising neodymium and praseodymium, wherein the weight percentage of neodymium is larger than the weight percentage of praseodymium but smaller than three times of the weight percentage of praseodymium; and,
less than about 5 weight percent of a heavy rare earth material.

2. The machine according to claim 1, wherein the stator comprises a stator core and a plurality of stator windings disposed in the stator core.

3. The machine according to claim 2, wherein the plurality of permanent magnets are disposed on the stator, magnetized circumferentially with alternating polarities along the circumferential direction, and the rotor comprises a rotor core and a plurality of protrusions functioning as rotor poles.

4. The machine according to claim 2, wherein the stator core comprises a plurality of C-shaped core parts arranged along a circumferential direction thereof each C-shaped core part defines a cavity for accommodating one of the stator windings, and the plurality of permanent magnets are located on the stator and each sandwiched between two adjacent C-shaped core parts.

5. The machine according to claim 1, wherein the plurality of permanent magnets are located on the rotor in spoke configurations.

6. The machine according to claim 1, wherein each of the plurality of permanent magnets is located on the rotor and in a V-shape configuration.

7. The machine according to claim 1, wherein each of the plurality of permanent magnets is located on the rotor and in a configuration combining a V-shape part and a U-shape part.

8. The machine according to claim 1, wherein the at least one of the plurality of permanent magnets comprises from about 23 weight percent to about 34 weight percent of the light rare earth material.

9. The machine according to claim 1, wherein the at least one of the plurality of permanent magnets comprises less than about 4.5 weight percent of dysprosium, less than about 0.8 weight percent of holmium and less than about 0.02 weight percent of terbium.

10. The machine according to claim 1, wherein the at least one of the plurality of permanent magnets comprises a metallic alloy component comprising niobium, copper, cobalt, aluminum, gallium, zirconium, or combinations thereof.

11. The machine according to claim 10, wherein the balance of the at least one of the plurality of permanent magnets comprises iron, boron or a combination thereof, with or without impurities.

12. The machine according to claim 1, wherein the at least one of the plurality of permanent magnets comprises about 0.1 weight percent to about 0.5 weight percent of niobium.

13. The machine according to claim 1, wherein the at least one of the plurality of permanent magnets comprises more than about 0.2 weight percent of copper.

14. The machine according to claim 1, wherein the at least one of the plurality of permanent magnets comprises more than about 1 weight percent of aluminum.

15. The machine according to claim 14, wherein the at least one of the plurality of permanent magnets comprises smaller than about 0.02 weight percent of dysprosium and larger than about 1.5 weight percent of aluminum.

16. The machine according to claim 14, wherein the at least one of the plurality of permanent magnets comprises larger than about 0.02 weight percent of dysprosium and from about 1 weight percent to about 1.5 weight percent of aluminum.
